(19) United States
(12) Patent Application Publication
(10) Pub. No.: US 2023/0387953 A1
(43) Pub. Date: Nov. 30, 2023

(54) COMMUNICATION SYSTEM AND COMMUNICATION METHOD

(71) Applicant: NEC Corporation, Tokyo (JP)

(72) Inventor: Osamu HASEGAWA, Tokyo (JP)

(73) Assignee: NEC Corporation, Tokyo (JP)

(21) Appl. No.: 18/198,500

(22) Filed: May 17, 2023

(30) Foreign Application Priority Data
May 24, 2022 (JP) 2022-084211

(51) Int. Cl. H04B 1/12; H04B 1/7105

(52) U.S. Cl. CPC H04B 1/123; H04B 1/71055

(57) ABSTRACT

A communication system in which a hub station and multiple terminal stations communicate at the same time using the same channel The hub station generates a transmission signal, generates a cancellation signal combines the transmission signal regarding the transmission signal and the cancellation signal, transmits the combined signal, and calculates an adaptive filter minimizing a power of an error signal with respect to the known signal. The terminal station calculates the error signal, generates the known signal for a terminal station causing interference in the interference signal, calculates a correction amount of a filter coefficient in the adaptive filter, and transmits the correction amount. The hub station calculates an adaptive filter calculates the filter coefficient based on the correction amount, and generates the cancellation signal by performing a filtering process using the adaptive filter on the signal to be transmitted to the other of the terminal stations.

This application is based upon and claims the benefit of priority from Japanese patent application No. 2022-084211, filed May 24, 2022, the disclose of which is incorporated herein in its entirety by reference. method.

### TECHNICAL FIELD

The present disclosure relates to a communication system and a communication

### BACKGROUND ART

In point-to-point wireless communication systems using the microwave/millimeter-wave band, when communicating between one hub station and multiple terminal stations, multiple frequency channels must be provided or the angles between the terminal stations must be made large in order to avoid interference on the same frequency channel, and the frequency utilization efficiency becomes poor.

The interference includes two types, i.e., from the terminal stations to the hub station and from the hub station to the terminal stations. Since the interference at the hub station is separated (interference cancellation) into multiple signals by multiple receiving antennas in the hub station, it can be handled by existing interference cancellation technology such as XPIC (cross-polarization interference canceller).

The methods for cancelling interference at the terminal stations include two possibilities, i.e., receiving compensation at the terminal stations and transmission compensation at the hub station. The former possibility, receiving compensation, requires multiple signals to be separated (by interference cancelling) at a single receiving antenna, and thus involves a complicated algorithm and requires a large circuit. The latter possibility, transmission compensation, is a method in which a transmitter in the hub station transmits a combined signal obtained by combining a transmission signal with a compensation value that cancels an interference signal at the time of reception at the terminal stations.

As related technology, Patent Document 1 (Japanese Unexamined Patent Application Publication No. H10-173579) discloses an interference cancellation method in a spatial diversity communication system in which the same signal is transmitted from multiple antennas, wherein the method involves receiving, on the receiving side, signals that have been split in two on the transmission side and that have been transmitted with a complex coefficient C multiplied with one of the split signals; performing diversity combination of the two received signals that have been received; demodulating the combined output; determining the demodulated signal; and implementing control so that, when an interference signal is included in the demodulated signal, the complex coefficient C is multiplied on the transmission side so as to minimize the mean square of the error signal ε, the error signal ε being defined as the error occurring before and after the determination.

### SUMMARY

Therefore, the present disclosure has, as an example of an objective thereof, to provide a communication system and a communication method.

According to an example of an aspect disclosed herein, the communication system is a communication system having a hub station and multiple terminal stations, the hub station and the multiple terminal stations communicating at the same time using the same channel, wherein the hub station has a modulator that generates a transmission signal including a prescribed known signal when transmitting a signal to one of the terminal stations among the multiple terminal stations, a filter that generates a cancellation signal for cancelling, regarding the transmission signal, an interference signal due to a signal to be transmitted to another of the terminal stations, a combiner that generates a combined signal by combining the transmission signal and the cancellation signal, a transmitter that transmits the combined signal, and an updater that calculates an adaptive filter minimizing a power of an error signal between the prescribed known signal and the known signal included in the combined signal received by the one of the terminal stations, based on the error signal and the interference signal; each of the terminal stations has a calculator that calculates the error signal, a generator that generates the prescribed known signal for the other of the terminal stations associated with the interference signal, the prescribed known signal being included in the interference signal, a calculator that calculate a correction amount of a filter coefficient in the adaptive filter based on the calculated error signal and the generated known signal included in the interference signal, and a transmitter that transmits the correction amount; and the updater calculates the filter coefficient such that the power of the error signal is minimized based on the correction amount; and the filter generates the cancellation signal by performing a filtering process using the filter coefficient on the signal to be transmitted to the other of the terminal stations.

According to an example of an aspect disclosed herein, the communication method is a communication method for a hub station and multiple terminal stations to communicate at the same time using the same channel, wherein the communication method includes one of the terminal stations receiving a signal from the hub station and calculating an error signal between a prescribed known signal and a known signal included in the received signal, generating the prescribed known signal for another of the terminal stations associated with an interference signal due to a signal to be transmitted from the hub station to the other of the terminal stations, the prescribed known signal being included in the interference signal, calculating a correction amount of a filter coefficient in an adaptive filter based on the calculated error signal and the generated known signal included in the interference signal, and transmitting the correction amount to the hub station; and the hub station calculating the filter coefficient such that a power of the error signal is minimized based on the correction amount, generating a transmission signal including the prescribed known signal, generating a cancellation signal for cancelling the interference signal by performing a filtering process using the filter coefficient on the signal to be transmitted to the other of the terminal stations, generating a combined signal by combining the transmission signal and the cancellation signal, and transmitting the combined signal to the one of the terminal stations.

### BRIEF DESCRIPTION OF THE DRAWINGS

FIG. 1 is a diagram depicting an example of a communication system provided with an interference cancellation function according to an embodiment.

FIG. 2 is a first diagram depicting an example of a transmitter/receiver in a communication system according to an embodiment.

FIG. 3A is a diagram depicting an example of a frame format for transmission from a hub station to a terminal station according to an embodiment.

FIG. 3B is a diagram depicting an example of a frame format for transmission from a terminal station to a hub station according to an embodiment.

FIG. 4A is a diagram depicting an example of a frame format for transmission from a hub station to a terminal station, associated with a block LMS input signal in an embodiment.

FIG. 4B is a diagram depicting an example of a configuration associated with updating a transmission compensation coefficient according to an embodiment.

FIG. 5 is a diagram indicating examples of frame formats before and after initial acquisition according to an embodiment.

FIG. 6 is a second diagram depicting an example of a transmitter/receiver in a communication system according to an embodiment.

FIG. 7 is a third diagram depicting an example of a transmitter/receiver in a communication system according to an embodiment.

FIG. 8 is a flow chart depicting an example of the operations in a communication system according to an embodiment.

FIG. 9 is a schematic diagram depicting an example of a communication system not provided with an interference cancellation function.

FIG. 10 is a diagram depicting an example of a communication system having the minimum configuration.

FIG. 11 is a diagram depicting an example of the operations in a communication system having the minimum configuration.

### EXAMPLE EMBODIMENT

### Embodiments

Hereinafter, a communication system according to an embodiment disclosed herein will be explained with reference to the drawings. Regarding the configurations of portions unrelated to the present disclosure in the drawings used in the explanation below, as well as repeated configurations and redundant configurations, the descriptions may be omitted or not illustrated.

### SUMMARY

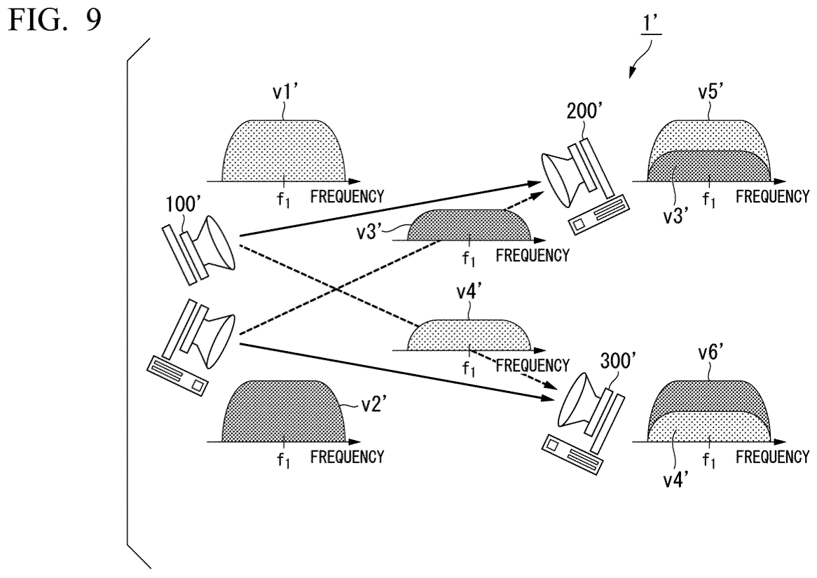

First, narrow-angle communication of a hub station 100′ not having an interference cancellation function with a terminal station 200′ and a terminal station 300′ will be explained with reference to FIG. 9. The hub station 100′ transmits the transmission signal v1' to the terminal station 200′ and transmits the transmission signal v2′ to the terminal station 300′ using the same frequency channel. The terminal station 200′ receives a received signal v5′ that is a combination of the transmission signal v1′ and an interference signal v3′ due to the signal transmitted to the terminal station 300′. The terminal station 300′ receives a received signal v6′ that is a combination of the transmission signal v2′ and an interference signal v4′ due to the signal transmitted to the terminal station 200′. When narrow-angle communication is performed on the same frequency channel in this way, receiving quality at the terminal stations 200′, 300′ is degraded. When the receiving quality is poor, the number of modulation levels in the modulation scheme, i.e., the transmission capacity, cannot be increased.

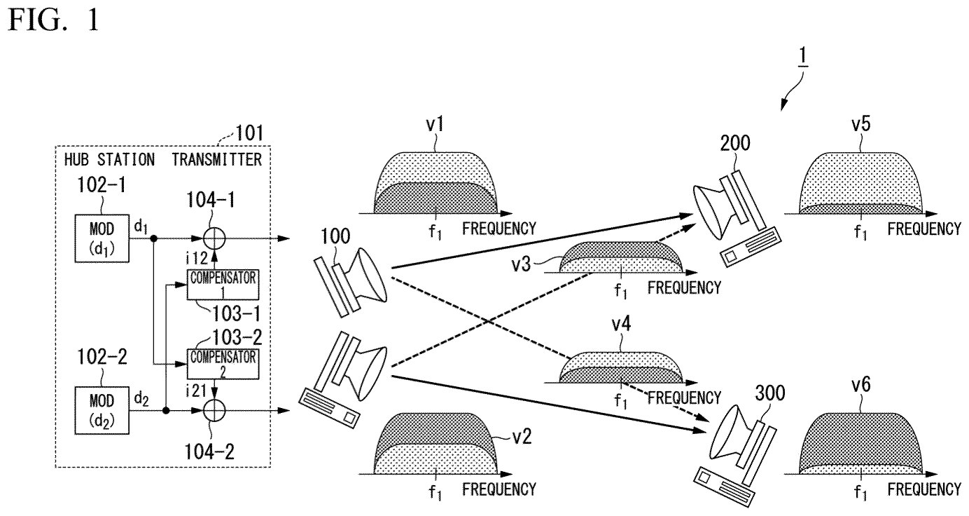

In contrast therewith, an example of a communication system 1 in which a transmitter 101 in a hub station 100 is provided with an interference cancellation function is depicted in FIG. 1. In the communication system 1, transmission compensators 103-1, 103-2 are provided in the transmitter 101 in the hub station 100. Transmission compensation in the transmitter 101 is performed by pre-combining, with the transmission signals, compensation values that cancel out at the time of reception at the terminal stations 200, 300. The transmitter 101 has modulators 102-1, 102-2, transmission compensators 103-1, 103-2, and combiners 104-1, 104-2.

The modulator 102-1 generates a modulated signal d1 by modulating a signal d1 to be transmitted to the terminal station 200, and the modulator 102-2 generates a modulated signal d2 by modulating a signal d2 to be transmitted to the terminal station 300. The transmission compensator 103-1 generates a cancellation signal i12 for cancelling interference that will occur due to the signal transmitted to the terminal station 300. The transmission compensator 103-2 generates a cancellation signal i21 for cancelling interference that will occur due to the signal transmitted to the terminal station 200. The combiner 104-1 generates a transmission signal v1 by combining the cancellation signal i12 with the modulated signal d1, and the combiner 104-2 generates a transmission signal v2 by combining the cancellation signal i21 with the modulated signal d2.

The transmitter 101 transmits the transmission signal v1 to the terminal station 200 and transmits the transmission signal v2 to the terminal station 300 using the same frequency channel. The received signal v5 of the terminal station 200 is combined with an interference signal v3 due to the transmission signal v2 to the terminal station 300, but it is cancelled by the cancellation signal i21 included in the transmission signal v1, so that a signal close to the modulated signal d1 is received at the terminal station 200. The received signal v6 at the terminal station 300 is combined with an interference signal v4 due to the transmission signal v1 to the terminal station 200, but it is cancelled by the cancellation signal i12 included in the transmission signal v2, so that a signal close to the modulated signal d2 is received at the terminal station 300.

In this way, interference at the time of reception at the terminal stations 200, 300 is cancelled by transmission compensation at the hub station 100. Since the amount of interference in the received signals is reduced, the number of modulation levels in the modulation scheme, i.e., the transmission capacity, can be increased. Hereinafter, the transmission compensation method will be explained in more detail.

### System Configuration

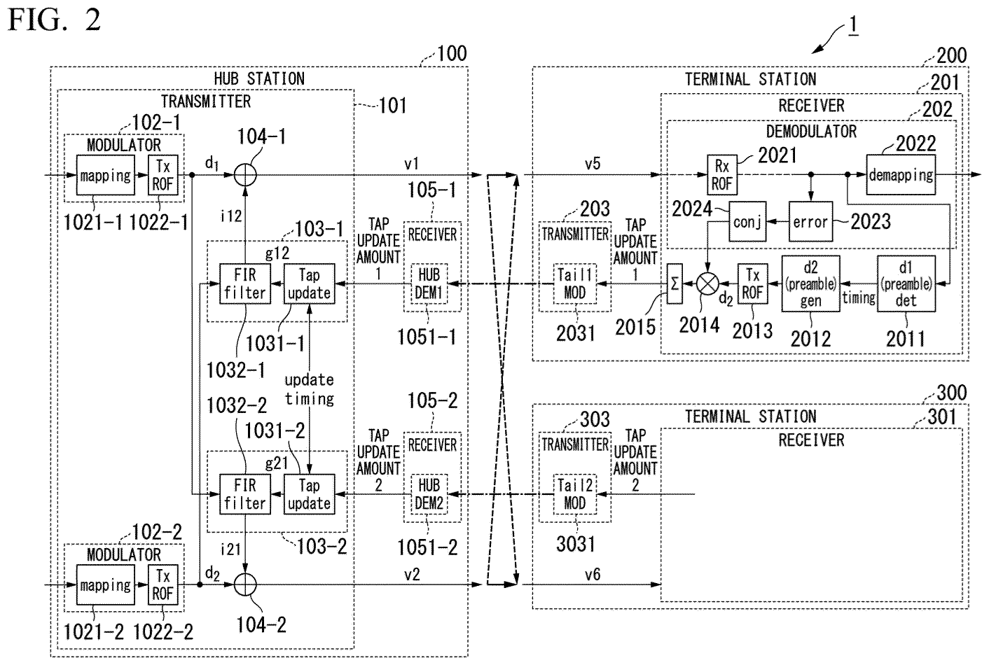

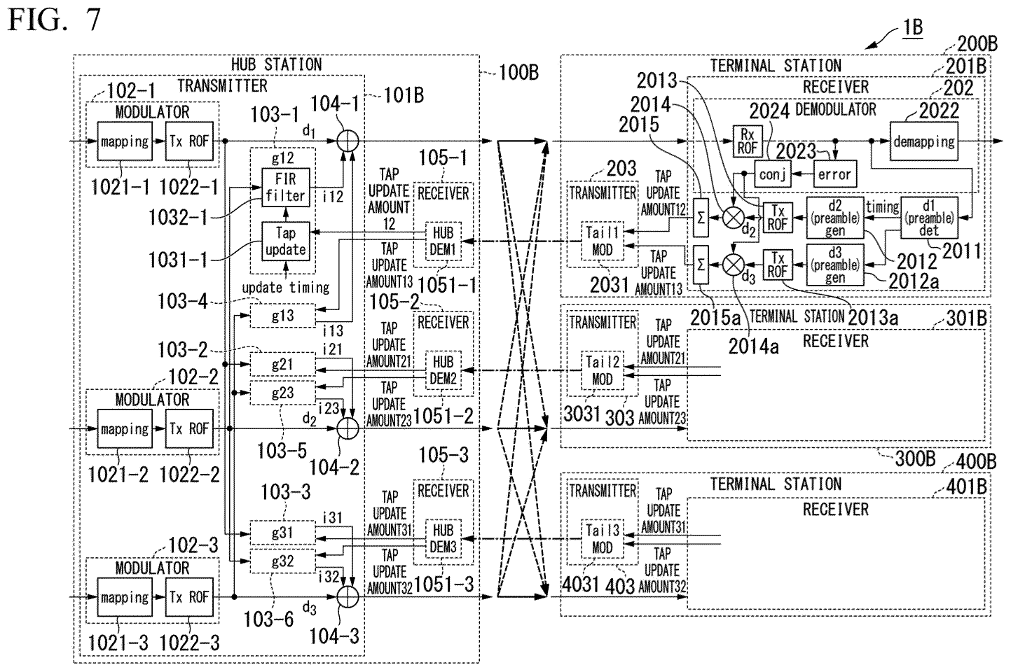

FIG. 2 is a block diagram depicting an example of a transmitter/receiver in the communication system according to an embodiment. As depicted in FIG. 2, the communication system 1 has a hub station 100 and terminal stations 200, 300. These apparatuses are, for example, bi-directional communication apparatuses using FDD (Frequency-Division Duplex) or TDD (Time-Division Duplex). Additionally, while FIG. 2 depicts a configuration for the case in which there are two terminal stations, the configuration may have three or more terminal stations (FIG. 7). The hub station 100 has a transmitter 101 and receivers 105-1, 105-2.

### Transmitter in Hub Station

The transmitter 101 has modulators 102-1, 102-2, transmission compensators 103-1, 103-2, and combiners 104-1, 104-2.

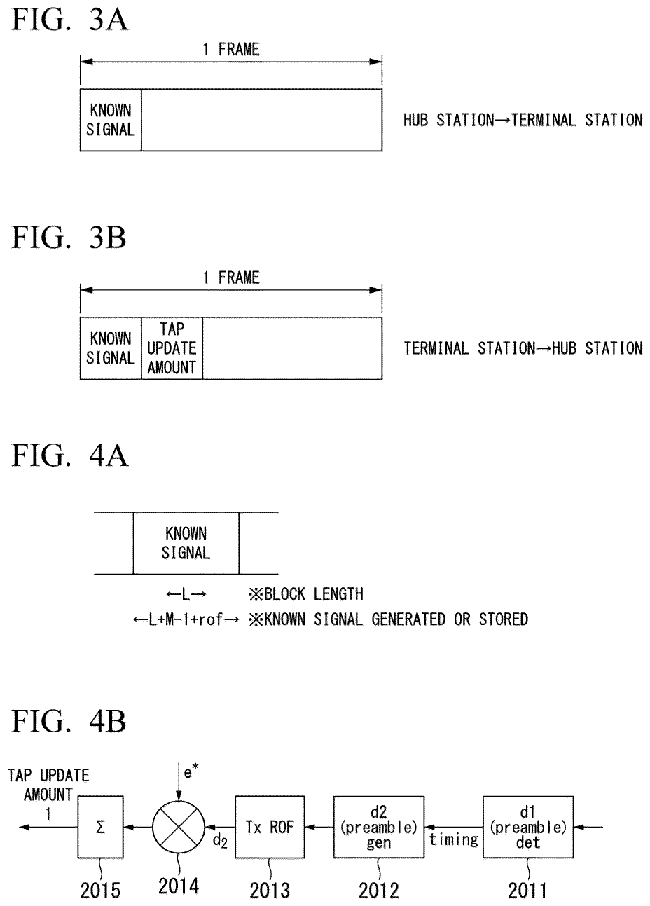

The modulator 102-1 has a mapping unit 1021-1 and a transmission ROF (Roll-Off Filter) unit 1022-1. The modulator 102-1 performs, on the signal d1 to be transmitted to the terminal station 200, a mapping process using the mapping unit 1021-1 and a modulation process, such as transmission roll-off filtering, using the transmission ROF unit 1022-1, and outputs a modulated signal d1. The modulator 102-2 has a mapping unit 1021-2 and a transmission ROF unit 1022-2. The modulator 102-2 performs, on the signal d2 to be transmitted to the terminal station 300, a mapping process using the mapping unit 1021-2 and a modulation process, such as transmission roll-off filtering, using the transmission ROF unit 1022-2, and outputs a modulated signal d2. An example of the layout of the modulated signals d1, d2 is depicted in FIG. 3A. As illustrated, a prescribed known signal is included at the head of each modulated signal d1, d2. In the present embodiment, the prescribed known signal is, for example, a preamble signal. The modulated signals d1, d2 are examples of the “transmission signal” in the claims.

The transmission compensator 103-1 has a tap updating unit 1031-1 and an FIR (Finite Impulse Response) filter unit 1032-1. The tap updating unit 1031-1 updates an FIR filter tap coefficient w in a block LMS (Least Mean Square) algorithm in an adaptive filter by means of Expression (1) below. The FIR filter tap coefficient is also referred to as a transmission compensation coefficient.

wₙ(k+L)=wₙ(k)+μsₙ(k) (1)

In the above expression, w represents the transmission compensation coefficient (FIR filter tap coefficient), M represents the tap length, L represents the block (known signal) length [symbols], μ represents the step size, s represents the tap update amount for M taps, k represents time, and n represents a terminal station number for a local terminal station (desired) signal (the terminal station 200 is n=1 and the transmission compensation coefficient is w1). The tap update amount s is transmitted from the terminal station 200. The tap update amount s will be explained below.

The FIR filter unit 1032-1 generates a cancellation signal i12 by performing, on the modulated signal d2, an FIR filter process by the transmission compensation coefficient w₁.

The transmission compensator 103-2 has the tap updating unit 1031-2 and the FIR filter unit 1032-2. The tap updating unit 1031-2 uses Expression (1) above to update the transmission compensation coefficient w₂ in the block LMS algorithm. The FIR filter unit 1032-2 generates the cancellation signal i21 based on the transmission compensation coefficient w₂ and the modulated signal d1. The functions themselves of the tap updating unit 1031-2 and the FIR filter unit 1032-2 are respectively the same as those of the tap updating unit 1031-1 and the FIR filter unit 1032-1.

The combiner 104-1 generates the transmission signal v1 by combining the modulated signal d1 and the cancellation signal i12. The combiner 104-2 generates the transmission signal v2 by combining the modulated signal d2 and the cancellation signal i21. The transmission signals v1, v2 are examples of the “combined signal” in the claims.

The transmitter 101 transmits the transmission signal v1 to the terminal station 200 and transmits the transmission signal v2 to the terminal station 300 at the same time using the same channel.

### Receiver in Hub Station

The receiver 105-1 has a demodulator 1051-1, and uses the demodulator 1051-1 to execute a demodulation process, such as receiving roll-off filtering, carrier recovery, clock recovery, error signal calculation, or equalization, to extract a “tap update amount 1” included in a signal received from the terminal station 200. The tap update amount refers to s (s1 in the terminal station 200) in Expression (1) above. The receiver 105-1 outputs the extracted “tap update amount 1” to the tap updating unit 1031-1. Similarly, the receiver 105-2 has a demodulator 1051-2, and uses the demodulator 1051-2 to execute a demodulation process, such as receiving roll-off filtering, carrier recovery, clock recovery, error signal calculation, or equalization, to extract a “tap update amount 2” included in a signal received from the terminal station 300. The receiver 105-2 outputs the extracted “tap update amount 2” to the tap updating unit 1031-2.

### Receivers in Terminal Stations

The terminal station 200 has a receiver 201 and a transmitter 203. The receiver 201 receives the received signal v5 obtained by combining the interference signal v3 with the transmission signal v1 transmitted from the hub station 100. The receiver 201 has a demodulator 202, a desired-signal known signal detection unit 2011, an interfering-signal known signal generation unit 2012, a transmission ROF unit 2013, a multiplier unit 2014, and a tap update amount calculation unit 2015. The demodulator 202 has an ROF unit 2021 that performs receiving roll-off filtering, a demapping unit 2022, an error signal calculation unit 2023, and a complex conjugate computation unit 2024. The demodulator 202 performs demodulation such as receiving roll-off filtering, carrier recovery, clock recovery, or equalization. During the demodulation processing step, the error signal calculation unit 2023 calculates an error signal (“error signal 1”). In this case, if the “error signal 1” is defined as e1, then in the terminal station 200, the error signal e1 for the case of the known signal interval is the difference between the signal r1′ and the modulated signal d1 included in the received signal v5 (e1=d1−r1′). In this case, the signal r1′ is the signal obtained after the series of demodulation processes has ended (the demodulated demapping input signal). The error signal calculation unit 2023 outputs the “error signal 1” to the complex conjugate computation unit 2024. The complex conjugate computation unit 2024 computes the complex conjugate of the “error signal 1” and outputs the computation result thereof to the multiplier unit 2014. Additionally, the demodulated signal is demapped by the demapping unit 2022.

The desired-signal known signal detection unit 2011 detects, in a demodulated received signal, a known signal (the known signal in the modulated signal d1) that is included in a local terminal signal (desired signal). For example, the desired-signal known signal detection unit 2011 stores the content of the known signal in the desired signal and detects the known signal on the basis of said content. When the desired-signal known signal detection unit 2011 detects the known signal in the desired signal, the interfering-signal known signal generation unit 2012, at that timing, generates an interfering-signal known signal (the known signal in the modulated signal d2 to the terminal station 300). For example, the interfering-signal known signal generation unit 2012 stores the content of the known signal in the interfering signal and generates the known signal on the basis of said content. The transmission ROF unit 2013 performs a filtering process, such as a transmission roll-off filter, on the generated known signal in the interference signal, and outputs the signal obtained by modulating the known signal in the interference signal to the multiplier unit 2014. The signal obtained by modulating the known signal in the interference signal is the input signal to the block LMS. The multiplier unit 2014 multiplies the modulated signal with the complex conjugate signal of the “error signal 1”, and the tap update amount calculation unit 2015 calculates their sum. The multiplier unit 2014 and the tap update amount calculation unit 2015 calculate the tap update amount of the block LMS by using the following Expression (2). e′ represents the complex conjugate of e.

$${s}_{n} ( k ) = {\sum }_{l = k}^{k + L - 1} {d}_{{n}^{′}} ( l ) {e}_{n}^{*} ( l ) \qquad ( 2 )$$

In the above expression, L represents the block length [symbols], d represents the input signal to the block LMS of the known signal (the known signal in the interference signal) for L+M−1 terms, e represents error signals for L terms, s represents the tap update amount for M taps, k and l represent time, n represents the terminal station number for the local terminal station (desired) signal, and n′ represents the terminal station number for the interference signal.

Regarding the terms in the sigma on the right side of Expression (2), signals for L+M−1 terms are required, as indicated in Expression (3) below.

$$[ \begin{matrix}{d}_{{n}^{′}} ( k ) & {d}_{{n}^{′}} ( k + 1 ) & {d}_{{n}^{′}} ( k + 2 ) & & {d}_{{n}^{′}} ( k + L - 2 ) & {d}_{{n}^{′}} ( k + L - 1 ) \\ {d}_{{n}^{′}} ( k - 1 ) & {d}_{{n}^{′}} ( k ) & {d}_{{n}^{′}} ( k + 1 ) & & {d}_{{n}^{′}} ( k + L - 3 ) & {d}_{{n}^{′}} ( k + L - 2 ) \\ {d}_{{n}^{′}} ( k - 2 ) & {d}_{{n}^{′}} ( k - 1 ) & {d}_{{n}^{′}} ( k ) & & {d}_{{n}^{′}} ( k + L - 4 ) & {d}_{{n}^{′}} ( k + L - 3 ) \\ ⋮ & ⋮ & ⋮ & ⋱ & ⋮ & ⋮ \\ {d}_{{n}^{′}} ( k - M + 1 ) & {d}_{{n}^{′}} ( k - M + 2 ) & {d}_{{n}^{′}} ( k - M + 3 ) & & {d}_{{n}^{′}} ( k + L - M - 1 ) & {d}_{{n}^{′}} ( k + L - M )\end{matrix} ] \qquad ( 3 )$$

$$[ \begin{matrix}{e}_{n}^{*} ( k ) \\ {e}_{n}^{*} ( k + 1 ) \\ {e}_{n}^{*} ( k + 2 ) \\ ⋮ \\ {e}_{n}^{*} ( k + L - 1 )\end{matrix} ]$$

Additionally, the information regarding the tap update amount s may be simplified. The simplification involves using an operation for outputting only the sign of the signal, as indicated in the following Expression (4).

c sgn(a)=sgn(Re(a))+j· sgn(Im(a)) (4)

In this case, c sgn is the sgn function for the complex number a. If sgn(0)=+1, then it can be output as the MSB (most significant bit), which is a single bit.

Specific examples of simplification are indicated in the five examples below. All of the simplification methods can reduce the amount of information transmitted to the hub station 100 and the amount of computation of the tap update amount s.

### Simplification 1

The first method is to simplify the input signal to the block LMS, as indicated by Expression (5) below. If the known signal uses a modulation scheme with a fixed amplitude value, such as QPSK (Quadrature Phase Shift Keying) or BPSK (Binary Phase Shift Keying), then the amplitude can be applied by the tap update in the hub station 100. Thus, the amount of feedback information can be reduced.

$${s}_{n} ( k ) = {\sum }_{l = k}^{k + L - 1} c sgn ( {d}_{{n}^{′}} ( l ) ) {e}_{n}^{*} ( l ) \qquad ( 5 )$$

### Simplification 2

The second method is to simplify the input signal to the block LMS and the error signal, as indicated by Expression (6) below. After (Simplification 1) above, the error signal is also simplified by c sgn. In this method, the known signal is basically limited to using a modulation scheme with a fixed amplitude value, such as QPSK or BPSK.

$${s}_{n} ( k ) = {\sum }_{l = k}^{k + L - 1} c sgn ( {d}_{{n}^{′}} ( l ) ) c sgn ( {e}_{n}^{*} ( l ) ) \qquad ( 6 )$$

### Simplification 3

The third method is to simplify the error signal, as indicated by Expression (7) below. With this method, there is no need to limit the modulation scheme of the known signal.

$${s}_{n} ( k ) = {\sum }_{l = k}^{k + L - 1} {d}_{{n}^{′}} ( l ) c sgn ( {e}_{n}^{*} ( l ) ) \qquad ( 7 )$$

### Simplification 4

The fourth method is to simplify the tap update amount, as indicated by Expression (8) below. After computing Expression (3) above, the computation result thereof is simplified by the c sgn function. With this method, there is no need to limit the modulation scheme of the known signal.

$${s}_{n} ( k ) = c sgn ( {\sum }_{l = k}^{k + L - 1} {d}_{{n}^{′}} ( l ) {e}_{n}^{*} ( l ) ) ) \qquad ( 8 )$$

### Simplification 5

The fifth method is to simplify the tap update amount in another way, as indicated by Expression (9) below. With this method, there is no need to limit the modulation scheme of the known signal. Although the amount of information transmitted to the hub station 100 is the same as that in Expression (8) in (Simplification 4), the computation amount for updating the tap is further reduced.

$${s}_{n} ( k ) = c sgn ( {\sum }_{l = k}^{k + L - 1} c sgn ( {d}_{{n}^{′}} ( l ) ) c sgn ( {e}_{n}^{*} ( l ) ) ) ) \qquad ( 9 )$$

In Expression (9), it is possible to simplify only d or e* by the c sgn function.

### Transmitters in Terminal Stations

The transmitter 203 has a modulator 2031. The modulator 2031 modulates signals to be transmitted to the hub station 100. The transmitter 203 transmits the modulated signals to the hub station 100. Regarding the tap update amount s₁ (“tap update amount 1”) for the known signal from the hub station 100 to the terminal station 200, after initial acquisition in the demodulation process in the terminal station 200, the transmission signals, in which information regarding the “tap update amount 1” calculated by the above-described method is included in frame format, are transmitted (fed back) from the terminal station 200 to the hub station 100. FIG. 3B indicates an example of the layout of a signal transmitted by the terminal station 200. As illustrated, the prescribed known signal is included at the head of the signal, and the tap update amount follows thereafter. The “tap update amount 1” (s₁(k) in Expression (1)) is used to update the transmission compensation coefficient w₁ in the hub station 100.

The matters explained regarding the terminal station 200 similarly apply to the terminal station 300. The terminal station 300 has a receiver 301 and a transmitter 303. The receiver 301 receives a received signal v6 that is a combination of the interference signal v4 and the transmission signal v2 transmitted from the hub station 100. Although the specifics have been omitted from the illustration, the receiver 301 has a configuration similar to that of the receiver 201 in the terminal station 200, such as a demodulator 302 and a tap update amount calculation unit 3015 (not illustrated). Although the specifics have been omitted from the illustration, the demodulator 302 has a configuration similar to that of the demodulator 202 in the terminal station 200, such as an error signal calculation unit 3023 (not illustrated). The receiver 301, if within a known signal interval, calculates an error signal between the known signal in the modulated signal d2 included in the received signal v6, and the demapping input signal. Additionally, the receiver 301, at the timing at which the known signal included in the local terminal station signal (the known signal in the modulated signal d2) is detected, generates the known signal in the interference signal (the known signal in the modulated signal d1) and performs a series of modulation processes such as transmission roll-off filtering. Furthermore, the “tap update amount 2” is calculated by one of Expressions (2) and (5) to (9) above, and the transmitter 303 transmits (feeds back) a signal including the “tap update amount 2” to the hub station 100. The “tap update amount 2” (s₂(k) in Expression (1)) is used to update the transmission compensation coefficient w2 in the hub station 100.

For example, when the “tap update amount 1” is transmitted from the terminal station 200 to the hub station 100, at the hub station 100, the tap updating unit 1031-1 receives the “tap update amount 1” through the receiver 105-1, and updates the transmission compensation coefficient w₁.

Examples of expressions for updating the transmission compensation coefficient w are indicated below. Expression (10) is the updating expression for the case in which the tap update amount s is calculated by Expression (2). Expression (11) is the updating expression for the case in which the tap update amount s is calculated by Expression (5) of (Simplification 1). Expression (12) is the updating expression for the case in which the tap update amount s is calculated by Expression (6) of (Simplification 2). Expression (13) is the updating expression for the case in which the tap update amount s is calculated by Expression (7) of (Simplification 3). Expression (14) is the updating expression for the case in which the tap update amount s is calculated by Expression (8) of (Simplification 4). Expression (15) is the updating expression for the case in which the tap update amount s is calculated by Expression (9) of (Simplification 5).

$${w}_{n} ( k + L ) = {w}_{n} ( k ) + μ {\sum }_{l = k}^{k + L - 1} {d}_{{n}^{′}} ( l ) {e}_{n}^{*} ( l ) \qquad ( 10 )$$

$${w}_{n} ( k + L ) = {w}_{n} ( k ) + μ \vert {d}_{{n}^{′}} ( l ) \vert {\sum }_{l = k}^{k + L - 1} {e}_{n}^{*} ( l ) \qquad ( 11 )$$

$${w}_{n} ( k + L ) = {w}_{n} ( k ) + μ {\sum }_{l = k}^{k + L - 1} c sgn ( {d}_{{n}^{′}} ( l ) ) c sgn ( {e}_{n}^{*} ( l ) ) \qquad ( 12 )$$

$${w}_{n} ( k + L ) = {w}_{n} ( k ) + μ {\sum }_{l = k}^{k + L - 1} {d}_{n}^{′} ( l ) c sgn ( {e}_{n}^{*} ( l ) ) \qquad ( 13 )$$

$${w}_{n} ( k + L ) = {w}_{n} ( k ) + μ c sgn ( {\sum }_{l = k}^{k + L - 1} {d}_{{n}^{′}} ( l ) {e}_{n}^{*} ( l ) ) ) \qquad ( 14 )$$

$${w}_{n} ( k + L ) = {w}_{n} ( k ) + μ c sgn ( {\sum }_{l = k}^{k + L - 1} c sgn ( {d}_{{n}^{′}} ( l ) ) c sgn ( {e}_{n}^{*} ( l ) ) ) ) \qquad ( 15 )$$

The tap updating unit 1031-1 uses one of Expression (10) to Expression (15) above to calculate an FIR filter tap coefficient (transmission compensation coefficient) w that minimizes the error signal e by means of a known block LMS algorithm.

### Handling of Input Signals

The input signals (d_{n′} above) to the block LMS by the interfering-signal known signal generation unit 2012 in the terminal station 200 may be generated in the following way (known signal extension type). In this method, the known signal included in the frame format of the modulated signal d2 is composed of L (block length)+M(number of taps)−1+filter part such as ROF (Roll-Off Filter) (longer than L (block length) computed by the block LMS), and the entire block LMS input signal is used as the known signal. An input signal to the block LMS is generated, at the timing at which a known signal included in the desired signal to the local terminal station 200 (the known signal in the modulated signal d1) is detected in the receiver 201 in the terminal station 200, by generating the known signal in the interference signal (the known signal in the modulated signal d2) and performing a series of modulation processes such as transmission roll-off filtering. An example of the frame format for the case of the known signal extension type is indicated in FIG. 4A. An example of a configuration for the case of generating the known signal in the interference signal is indicated in FIG. 4B. The same applies to the terminal station 300.

### Shortening of Initial Acquisition Time

Additionally, regarding the frame format at the time of initial acquisition of the transmission compensation coefficient w (when first calculating the transmission compensation coefficient), the three measures below may be taken at the time of initial acquisition in order to reduce the initial acquisition time.

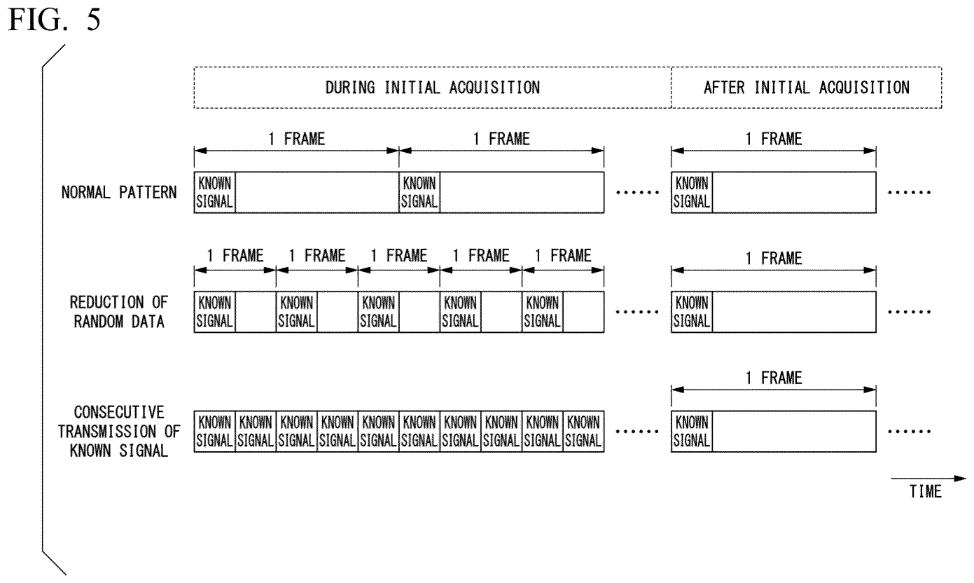

(A1) The first measure is to consecutively transmit the known signal or to reduce the random data. For example, when first calculating the transmission compensation coefficient w₁ (at the time of initial acquisition), as the frame format of the modulated signal d1 to be transmitted from the hub station 100 to the terminal station 200, just the known signal is repeated, or the random data is reduced in comparison with a normal (after initial acquisition) frame format. In this way, the required number of data for updating the tap in the block LMS can be quickly collected and the initial acquisition time can be shortened. The frame format for the case in which just the known signal is repeated is indicated in the line “Consecutive transmission of known signal” in FIG. 5, and the frame format for the case in which the random data is reduced is indicated in the line “Reduction of random data” in FIG. 5.
(A2) The second measure is to change the block length L and/or the step size it. By setting these values to be larger at the time of initial acquisition than the values after the initial acquisition, the initial acquisition time can be shortened.
(A3) The third measure is to perform the abovementioned (A1) and (A2) simultaneously.

Due to these measures, the transmission compensation coefficient w can be quickly set.

### Example of Configuration in Case of Error Correction Coding

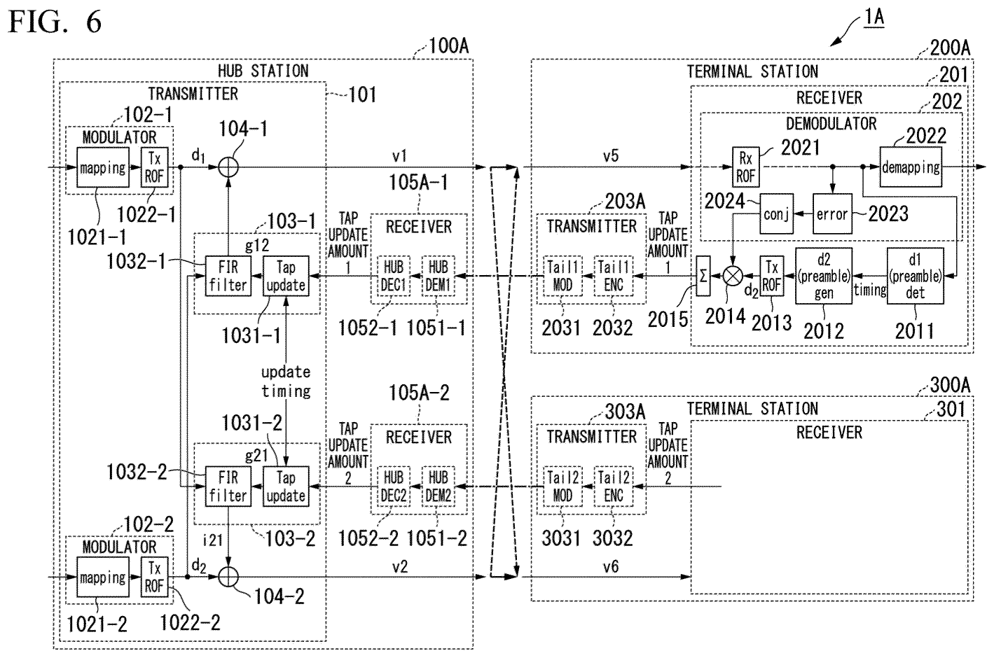

The error signals transmitted from the terminal stations 200, 300 may also be subjected to error correction coding. FIG. 6 depicts an example of the configuration of a communication system 1A in the case in which error correction coding is performed. The hub station 100A in the communication system 1A indicated in FIG. 6 has a transmitter 101 and receivers 105A-1, 105A-2. The receiver 105A-1 has a decoder 1052-1 in addition to the demodulator 1051-1, and the receiver 105A-2 has a decoder 1052-2 in addition to the demodulator 1051-2. The terminal station 200A has a receiver 201 and a transmitter 203A. The terminal station 300A has a receiver 301 and a transmitter 303A. The transmitter 203A in the terminal station 200A has an encoder 2032 in addition to the modulator 2031, and the transmitter 303A in the terminal station 300A has an encoder 3032 in addition to the modulator 3031.

The encoder 2032 encodes the “tap update amount 1” so as to allow error detection and correction. The modulator 2031 modulates the signal including the “tap update amount 1” after coding. The transmitter 203A transmits the modulated signal to the hub station 100A. In the hub station 100A, the receiver 105A-1 receives the signal, the decoder 1052-1 performs error detection and correction on the encoded “tap update amount 1” that has been extracted by the demodulator 1051-1, and outputs the demodulated “tap update amount 1” to the tap updating unit 1031-1.

The same applies to the encoder 3032 in the transmitter 303A in the terminal station 300A and to the decoder 1052-2 in the receiver 105A-2 in the hub station 100A. In FIG. 6, the specific configuration of the receiver 301 is omitted from the illustration. However, the configuration and functions thereof are similar to those of the receiver 201.

### Example of Configuration in Case of Three Terminal Stations

An example of the configuration for the case in which there are three terminal stations is depicted in FIG. 7. The communication system 1B has a hub station 100B and terminal stations 200B, 300B, 400B. The hub station 100B has a transmitter 101B and receivers 105-1, 105-2, 105-3. The transmitter 101B has modulators 102-1, 102-2, 102-3, transmission compensators 103-1, 103-2, 103-3, 103-4, 103-5, 103-6, and combiners 104-1, 104-2, 104-3. The transmission compensators 103-2, 103-3, 103-4, 103-5, 103-6 have functions and configurations similar to those of the transmission compensator 103-1. The terminal station 200B has a receiver 201B and a transmitter 203. The receiver 201B has a demodulator 202, a desired-signal known signal detection unit 2011, interfering-signal known signal generation units 2012, 2012a, transmission ROF units 2013, 2013a, multiplier units 2014, 2014a, and tap update amount calculation units 2015, 2015a. The interfering-signal known signal generation unit 2012, the transmission ROF unit 2013, the multiplier unit 2014, and the tap update amount calculation unit 2015 are as explained with reference to FIG. 2. The multiplier unit 2014 and the tap update amount calculation unit 2015 calculate the “tap update amount 12” of the block LMS by using one of Expression (2) and Expressions (5) to (9) above. When the desired-signal known signal detection unit 2011 detects the known signal in the desired signal, the interfering-signal known signal generation unit 2012a generates the known signal in the interference signal (the known signal in the modulated signal d3 to the terminal station 400B). The transmission ROF unit 2013a performs a filtering process, such as transmission roll-off filtering, on the generated known signal in the interference signal, and outputs a modulated signal, in which the known signal in the interference signal has been modulated, to the multiplier unit 2014a. The multiplier unit 2014a multiplies the modulated signal with a complex conjugate signal of the “error signal 1”, and the tap update amount calculation unit 2015a calculates the sum thereof The multiplier unit 2014a and the tap update amount calculation unit 2015a calculate the “tap update amount 13” of the block LMS by using one of Expression (2) and Expressions (5) to (9) above. The transmitter 203 transmits (feeds back) a signal including the “tap update amount 12” and the “tap update amount 13” to the hub station 100. In FIG. 7, the specific configurations of the terminal stations 300B, 400B are omitted from illustration. However, the configurations and functions thereof are similar to those of the terminal station 200B.

The generation of a transmission signal to be transmitted to the terminal station 200B will be explained. The modulator 102-1 generates the modulated signal d1. The transmission compensator 103-1 generates a cancellation signal i12 for cancelling an interference signal due to the signal transmitted from the hub station 100B to the terminal station 300B based on the modulated signal d2 generated by the modulator 102-2 and the transmission compensation coefficient w₁₂ calculated based on the “tap update amount 12”. The transmission compensator 103-4 generates a cancellation signal i13 for cancelling an interference signal due to the signal transmitted from the hub station 100B to the terminal station 400B based on the modulated signal d3 generated by the modulator 102-3 and the transmission compensation coefficient w₁₃ calculated based on the “tap update amount 13”. The combiner 104-1 combines the modulated signal d1, the cancellation signal i12, and the cancellation signal i13 to generate the transmission signal v1. The configuration of the transmission compensator 103-4 is similar to that of the transmission compensator 103-1. The same applies to the generation of the signals to be transmitted to the terminal stations 300B, 400B. Thus, in the case of a three-station configuration, the transmission compensation in the hub station 100B involves generating cancellation signals that compensate for terminal station interference from two stations, and generating a transmission signal by combining the cancellation signals for the two stations with the modulated signal to be transmitted.

Similarly, if there are four or more terminal stations, then the system is configured to generate cancellation signals that compensate for terminal station interference from three stations. The same applies to the case in which there are five or more terminal stations. In the configuration indicated in FIG. 7, for example, in the case in which there is little interference between the terminal station 200B and the terminal station 400B, the operations of the transmission compensator 103-4 and the transmission compensator 103-3 may be stopped, or these circuits may be omitted.

### Operations

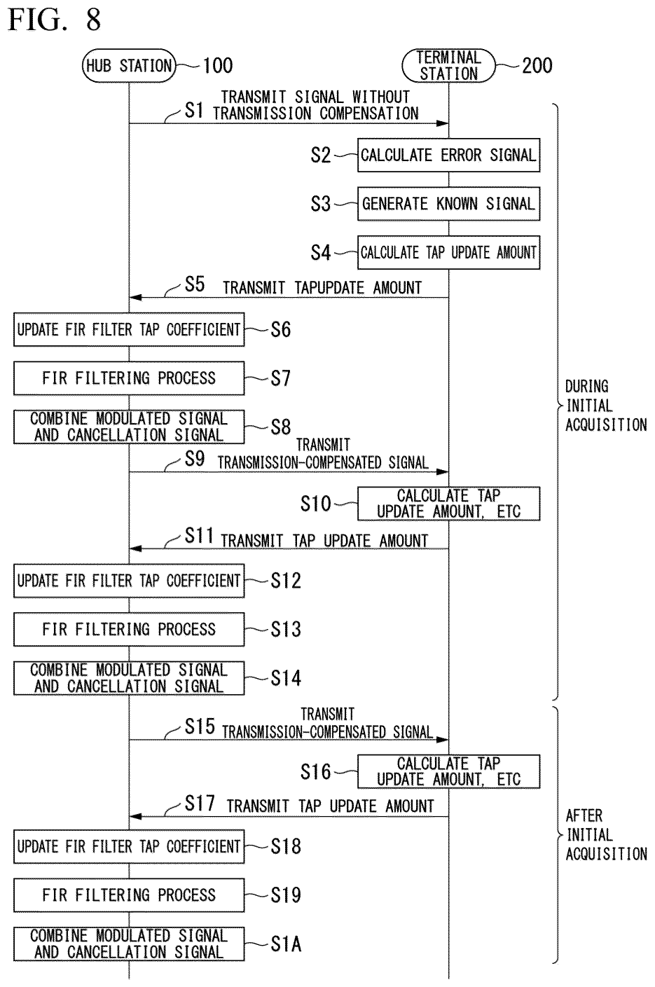

Next, using the configuration of FIG. 2 as an example, the operations of the communication system 1 will be explained with reference to FIG. 8. For convenience of explanation, the explanation will be made with communication between the hub station 100 and the terminal station 200 as an example. FIG. 8 is a flow chart indicating an example of the operations in the communication system according to an embodiment.

It will be assumed that the modulated signal d1 and the modulated signal d2 to be transmitted to the respective terminal stations 200, 300 are synchronized in terms of the timing in each symbol period and are synchronized in terms of carrier frequency. Additionally, the processes below (processes for transmission compensation for interference cancellation between terminal stations) are initiated under the assumption that the receiving quality in the hub station 100 is in a good and stable state (for example, a state in which a hub station receiving error power of −20 [dB] or lower is introduced), such as by introducing interference cancellation of the transmission signals from the terminal station 200 and the transmission signals from the terminal station 300. This is in order to keep the error signal information received at the hub station 100 free of errors.

If the modulation scheme for the known signal or the error signal is QPSK (Quadrature Phase-Shift Keying), BPSK (Binary Phase-Shift Keying), etc., in which the number of modulation levels is small, then the processes may be initiated even under conditions in which the receiving quality is relatively poor.

### During Initial Acquisition

During initial acquisition (before transmission compensation), only the modulated signal d1 is transmitted from the hub station 100 to the terminal station 200 (step S1). The frame format of this transmission signal includes a known signal. Additionally, the frame format at the time of initial acquisition may be the format indicated by “Reduction of random data” or “Consecutive transmission of known signal” in FIG. 5 ((A1) above). In the terminal station 200, the error signal calculation unit 2023 calculates the “error signal 1” (step S2). Additionally, the interfering-signal known signal generation unit 2012 generates the known signal in the interference signal (step S3). For each frame, the multiplier unit 2014 and the tap update amount calculation unit 2015 calculate the “tap update amount 1” in the block LMS by using one of Expression 2 and Expressions (5) to (9) above (step S4). At this time, the block length L or the step size μ may be set to a value larger than those after the initial acquisition ((A2) above). The transmitter 203 transmits a signal including the “tap update amount 1” to the hub station 100 (step S5). In the hub station 100, for each frame, the tap updating unit 1031-1 updates the FIR filter tap coefficient by means of Expression (1) (step S6). Next, the FIR filtering unit 1032-1 performs the FIR filtering process on the modulated signal d2 based on the FIR filter tap coefficient (step S7). As a result thereof, the cancellation signal i12 is generated. Next, the combiner 104-1 combines the modulated signal d1 with the cancellation signal i12 (step S8). As a result thereof, the transmission signal v1 is generated. Next, the transmitter 101 transmits the transmission-compensated signal (i.e., the transmission signal v1) (step S9). The terminal station 200 receives the received signal v5 and calculates the tap update amount, etc. (step S10). Specifically, as in steps S2 to S4 above, the “error signal 1” for the transmission signal v1 is calculated, the known signal in the interference signal is generated, and the “tap update amount 1” is calculated by using one of Expression 2 and Expressions (5) to (9). The terminal station 200 transmits a signal including that “tap update amount 1” to the hub station 100 (step S11). Then, the processes of steps S9 to S14 are repeated until the initial acquisition is completed (regarding the determination of completion of the initial acquisition, for example, the initial acquisition can be determined to have been completed when, for example, the square of the amplitude of the “error signal 1” or, for example, the average value of the power (when the error signal e1 is defined as e1=e1ᵢ+j×e1_{q}, where elᵢ is the real part of the error signal 1, e1_{q} is the imaginary part of the error signal 1, and * is the complex conjugate, the power of the error signal 1 is e1²=e1×el*=e1ᵢ²+e1_{q}²32 |e1|²) of the “error signal 1” becomes a prescribed threshold value or lower, or the initial acquisition can be determined to have been completed when an estimated SNR (Signal-to-Noise Ratio) becomes a prescribed set value or higher; alternatively, the initial acquisition can be determined to have been completed when a prescribed time period elapses after the initial acquisition starts or when a prescribed number of frames have been processed). Step S12 is a process for updating the FIR filter tap coefficient, similar to step S6. Step S13 is an FIR filtering process for the modulated signal d2, similar to step S7. Step S14 is a process, by the combiner 104-1, for combining the modulated signal d1 with the cancellation signal i12, similar to step S8. The tap updating unit 1031-1 updates the FIR filter tap coefficient by repeating the processes in steps S9 to S14. In an adaptive algorithm for a block LMS, the FIR filter tap coefficient is automatically updated, by an MMSE (Minimum Mean Square Error) criterion, so as to minimize the power of the error signal.

### After Initial Acquisition

When the initial acquisition is completed, post-initial acquisition processes are executed. Specifically, prescribed values (values smaller than those at the time of initial acquisition) are set for the block length L and the step size μ, and the transmitter 101 transmits a transmission-compensated signal (i.e., the transmission signal v1) (step S15). In the terminal station 200, the “tap update amount 1”, etc. are calculated (step S16), and a signal including the “tap update amount 1” is transmitted to the hub station 100 (step S17). In the hub station 100, the tap updating unit 1031-1 updates the FIR filter tap coefficient (step S18). Next, the FIR filtering unit 1032-1 performs an FIR filter process on the modulated signal d2 based on the FIR filter tap coefficient, thereby generating the cancellation signal i12 (step S19). Next, the combiner 104-1 combines the modulated signal d1 with the cancellation signal i12, thereby generating the transmission signal v1 (step S1A). After the initial acquisition, the known signal included in the transmission signal v1 becomes a normal pattern as indicated in the “After initial acquisition” column in FIG. 5. Thereafter, the processes of step S15 and later are repeated. cl Effects

According to the present embodiment, when communicating from one hub station to multiple terminal stations, interference between terminal stations on the same frequency channel is cancelled by transmission compensation in a transmitter in the hub station. As a result thereof, even when performing narrow-angle communication with multiple terminal stations, a single frequency channel can be shared by multiple terminal stations, thereby increasing the frequency utilization efficiency and the transmission efficiency, and allowing the operating cost to be reduced.

### Minimum configuration

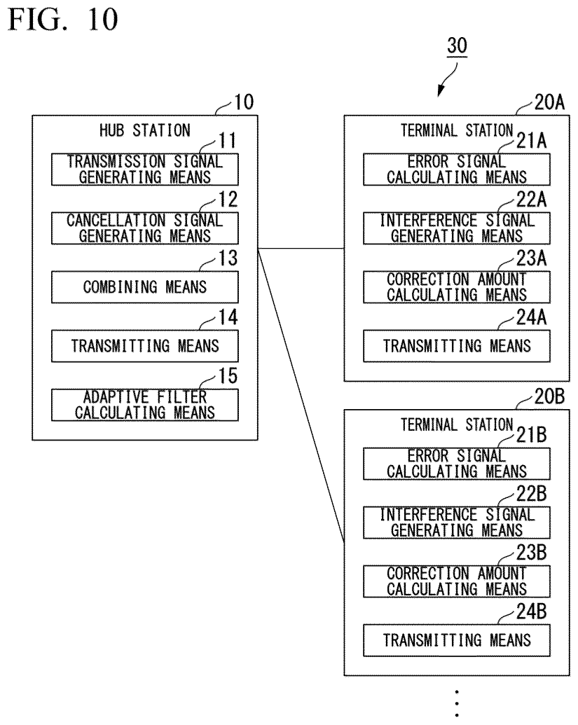

FIG. 10 is a block diagram indicating the configuration of a communication system having the minimum configuration.

The communication system 30 is provided with a hub station 10 and multiple terminal stations 20A, 20B, . . . . The communication system 30 implements communication from the hub station 10 to the multiple terminal stations 20A, 20B, . . . at the same time by using the same channel. The hub station 10 has transmission signal generating means (hereinafter also referred to as “modulator”) 11, cancellation signal generating means (hereinafter also referred to as “filter”) 12, combining means (hereinafter also referred to as “combiner”) 13, transmitting means (hereinafter also referred to as “transmitter”) 14, and adaptive filter calculating means (hereinafter also referred to as “updater”) 15. The transmission signal generating means 11 generates a transmission signal including a prescribed known signal (the known signal in the terminal station 20A) when transmitting a signal (frame) to one terminal station among the multiple terminal stations 20A, 20B, . . . , for example, to the terminal station 20A. The cancellation signal generating means 12 generates, regarding the transmission signal, a cancellation signal for cancelling an interference signal due to a signal to be transmitted to another terminal station, for example, to the terminal station 20B. The combining means 13 combines the transmission signal with the cancellation signal. The transmitting means 14 transmits the combined signal. The adaptive filter calculating means 15 calculates, using a block LMS algorithm, an adaptive filter such that the power of an error signal between the prescribed known signal (the known signal in the terminal station 20A including the frames originally directed to the terminal station 20A) and the known signal (the known signal that has been affected by the interference signal) included in the combined signal received by the terminal station 20A is minimized, based on the error signal and the interference signal.

The terminal station 20A has error signal calculating means (hereinafter also referred to as “calculator”) 21A for calculating an error signal, interference signal generating means (hereinafter also referred to as “generator”) 22A for generating a prescribed known signal for another terminal station (terminal station 20B that causes interference) associated with an interference signal, the prescribed known signal being included in the interference signal, correction amount calculating means (hereinafter also referred to as “calculator”) 23A for calculating a correction amount (“tap update amount 1”) of a filter coefficient in an adaptive filter based on the calculated error signal and the generated known signal included in the interference signal, and transmitting means (hereinafter also referred to as “transmitter”) 24A for transmitting the calculated correction amount. The terminal station 20B has error signal calculating means 21B for calculating an error signal, interference signal generating means 22B for generating a prescribed known signal for another terminal station (terminal station 20A that causes interference) associated with an interference signal, the prescribed known signal being included in the interference signal, correction amount calculating means 23B for calculating a correction amount (“tap update amount 2”) of a filter coefficient in an adaptive filter based on the calculated error signal and the generated known signal included in the interference signal, and transmitting means 24B for transmitting the calculated correction amount.

The adaptive filter calculating means 15 in the hub station 10 calculates a filter coefficient (transmission compensation coefficient (FIR filter tap coefficient) w) that minimizes the power of the error signal e based on the correction amount received from the terminal station 20A, and the cancellation signal generating means 12 generates a cancellation signal by performing a filtering process using the adaptive filter on the signal to be transmitted to the other terminal station (terminal station 20B).

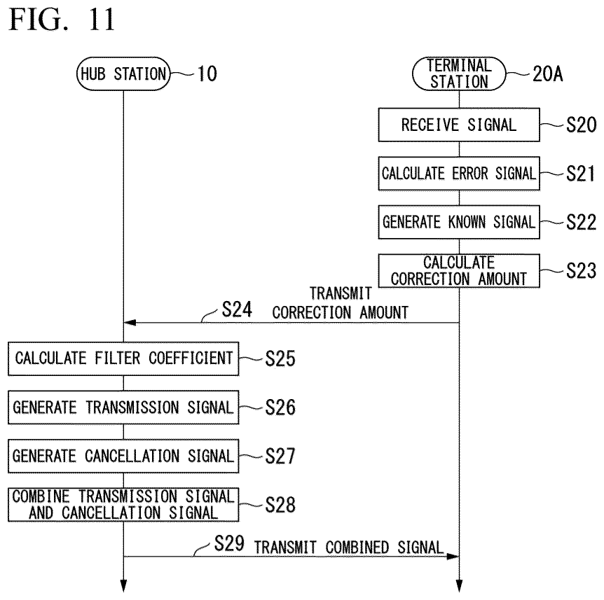

FIG. 11 is a flow chart indicating processes performed by the communication system having the minimum configuration.

The terminal station 20A receives a signal from the hub station 10 (step S20). The error signal calculating means 21A in the terminal station 20A calculates an error signal between a prescribed known signal and the known signal included in a combined signal received by the terminal station 20A (step S21). The interference signal generating means 22A generates a prescribed known signal for another terminal station (terminal station 20B that causes interference) associated with an interference signal due to a signal transmitted from the hub station 10 to the other terminal station (terminal station 20B), the prescribed known signal being included in the interference signal (step S22). Next, The correction amount calculating means 23A calculates a correction amount (“tap update amount 1”) for a filter coefficient (FIR filter tap coefficient) in an adaptive filter based on the calculated error signal and the generated known signal included in the interference signal (step S23). The transmitting means 24A in the terminal station 20A transmits the correction amount (step S24). The adaptive filter calculating means 15 in the hub station 10 calculates a filter coefficient for an adaptive filter such that the power of the error signal is minimized on the basis of the error signal and the correction amount based on the signal transmitted to the other terminal station 20B (step S25). The transmission signal generating means 11 generates a transmission signal to the terminal station 20A including the prescribed known signal (the known signal in the terminal station 20A) (step S26). The cancellation signal generating means 12 generates a cancellation signal by performing a filtering process using the calculated filter coefficient on the signal to be transmitted to the other terminal station 20B (step S27). The combining means 13 generates a combined signal by combining the transmission signal and the cancellation signal (step S28). The transmitting means 14 transmits the combined signal (the transmission signal v1 in FIG. 2) (step S29).

The whole or part of the example embodiments disclosed above can be described as, but not limited to, the following appendixes.

### Appendix 1

A communication system having a hub station and multiple terminal stations, the hub station and the multiple terminal stations communicating at the same time using the same channel, wherein: the hub station has means for generating a transmission signal (for example, the modulated signal d1) including a prescribed known signal when transmitting a signal to one of the terminal stations among the multiple terminal stations, means for generating a cancellation signal for cancelling, regarding the transmission signal, an interference signal due to a signal to be transmitted to another of the terminal stations, means for generating a combined signal (for example, the transmission signal v1) by combining the transmission signal and the cancellation signal, means for transmitting the combined signal, and means for calculating an adaptive filter minimizing a power of an error signal between the prescribed known signal and the known signal included in the combined signal received by the one of the terminal stations, based on the error signal and the interference signal; each of the terminal stations has means for calculating the error signal, means for generating the prescribed known signal for the other of the terminal stations associated with the interference signal, the prescribed known signal being included in the interference signal, means for calculating a correction amount of a filter coefficient in the adaptive filter based on the calculated error signal and the generated known signal included in the interference signal, and means for transmitting the correction amount; and the means for calculating an adaptive filter calculates the filter coefficient such that the power of the error signal is minimized based on the correction amount; and the means for generating a cancellation signal generates the cancellation signal by performing a filtering process using the filter coefficient on the signal to be transmitted to the other of the terminal stations.

### Appendix 2

The communication system according to Appendix 1, wherein, when L represents a block length, μ represents a step size, k represents time, s represents the correction amount, and n represents a number of the terminal station that is the transmission destination of the combined signal, the means for calculating the adaptive filter calculates an FIR filter tap coefficient wₙ in a block LMS (Least Mean Square) algorithm by using the expression below.

wₙ(k+L)=wₙ(k)+μsₙ(k)

### Appendix 3

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = {\sum }_{l = k}^{k + L - 1} {d}_{{n}^{′}} ( l ) {e}_{n}^{*} ( l )$$

### Appendix 4

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = {\sum }_{l = k}^{k + L - 1} c sgn ( {d}_{{n}^{′}} ( l ) ) {e}_{n}^{*} ( l )$$

### Appendix 5

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = {\sum }_{l = k}^{k + L - 1} c sgn ( {d}_{{n}^{′}} ( l ) ) c sgn ( {e}_{n}^{*} ( l ) )$$

### Appendix 6

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = {\sum }_{l = k}^{k + L - 1} {d}_{{n}^{′}} ( l ) c sgn ( {e}_{n}^{*} ( l ) )$$

### Appendix 7

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = c sgn ( {\sum }_{l = k}^{k + L - 1} {d}_{{n}^{′}} ( l ) {e}_{n}^{*} ( l ) ) )$$

### Appendix 8

The communication system according to Appendix 2, wherein, when L represents the block length, d represents an input signal to the block LMS, e represents the error signal, k and l represent time, n represents the number of the terminal station that is the transmission destination of the combined signal, and n′ represents a number of the other of the terminal stations associated with the interference signal (the terminal station causing the interference), the means for calculating the correction amount calculates s, which is the correction amount, by using the expression below.

$${s}_{n} ( k ) = c sgn ( {\sum }_{l = k}^{k + L - 1} c sgn ( {d}_{{n}^{′}} ( l ) ) c sgn ( {e}_{n}^{*} ( l ) ) ) )$$

### Appendix 9

The communication system according to any one of Appendix 2 to Appendix 8, wherein the input signal to the block LMS is composed of only the known signal (corresponding to the subject matter described in “Handling of input signal” above) to be included in the signal to be transmitted to the other of the terminal stations associated with the interference signal (the terminal station causing the interference).

### Appendix 10

The communication system according to any one of Appendix 2 to Appendix 9, wherein, when calculating the FIR filter tap coefficient wₙ during initial acquisition, the means for generating the transmission signal generates a signal repeating only the known signal, or generates a signal in which data to be transmitted to the one of the terminal stations is reduced in comparison with a signal after the initial acquisition.

### Appendix 11

The communication system according to any one of Appendix 2 to Appendix 10, wherein, when calculating the FIR filter tap coefficient wₙ during initial acquisition, the means for calculating the adaptive filter sets the block length L and/or the step size μ to a value larger than that after the initial acquisition.

### Appendix 12

A communication method for a hub station and multiple terminal stations to communicate at the same time using the same channel, wherein the communication method includes: one of the terminal stations receiving a signal from the hub station and calculating an error signal between a prescribed known signal and a known signal included in the received signal, generating the prescribed known signal for another of the terminal stations associated with an interference signal due to a signal to be transmitted from the hub station to the other of the terminal stations, the prescribed known signal being included in the interference signal, calculating a correction amount of a filter coefficient in an adaptive filter based on the calculated error signal and the generated known signal included in the interference signal, and transmitting the correction amount to the hub station; and the hub station calculating the filter coefficient such that a power of the error signal is minimized based on the correction amount, generating a transmission signal including the prescribed known signal, generating a cancellation signal for cancelling the interference signal by performing a filtering process using the filter coefficient on the signal to be transmitted to the other of the terminal stations, generating a combined signal by combining the transmission signal and the cancellation signal, and transmitting the combined signal to the one of the terminal stations.

As described above, interference cancellation technology is disclosed. When implementing communication from one hub station to multiple terminal stations, a method for cancelling interference between the terminal stations on the same frequency channel by transmission compensation in a transmitter of the hub station is sought.

According to the present disclosure, for example, interference between terminal stations on the same frequency channel can be cancelled.

While an embodiment disclosed herein has been explained in detail above with reference to the drawings, the specific configurations are not limited to those described above, and various design changes or the like are possible within a range not departing from the spirit of this disclosure. Additionally, an embodiment disclosed herein can be changed in various ways within the scope indicated by the claims, and embodiments obtained by appropriately combining technical means disclosed respectively in different embodiments are included within the technical scope disclosed herein. Additionally, configurations in which elements described in the above-mentioned embodiments and modified examples are replaced by elements providing similar effects are also included.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

What is claimed is:

1. A communication system having a hub station and multiple terminal stations, the hub station and the multiple terminal stations communicating at the same time using the same channel, wherein:
the hub station comprises
a modulator that generates a transmission signal including a prescribed known signal when transmitting a signal to one of the terminal stations among the multiple terminal stations,
a filter that generates a cancellation signal for cancelling, regarding the transmission signal, an interference signal due to a signal to be transmitted to another of the terminal stations,
a combiner that generates a combined signal by combining the transmission signal and the cancellation signal,
a transmitter that transmits the combined signal, and
an updater that calculates an adaptive filter minimizing a power of an error signal between the prescribed known signal and the known signal included in the combined signal received by the one of the terminal stations, based on the error signal and the interference signal;
each of the terminal stations comprises
a calculator that calculates the error signal,
a generator that generates the prescribed known signal for the other of the terminal stations associated with the interference signal, the prescribed known signal being included in the interference signal,
a calculator that calculates a correction amount of a filter coefficient in the adaptive filter based on the calculated error signal and the generated known signal included in the interference signal, and
a transmitter that transmits the correction amount; and
the updater calculates the filter coefficient such that the power of the error signal is minimized based on the correction amount; and
the filter generates the cancellation signal by performing a filtering process using the filter coefficient on the signal to be transmitted to the other of the terminal stations.

2. The communication system according to claim 1, wherein
when L represents a block length, μ represents a step size, k represents time, s represents the correction amount, and n represents a number of the terminal station that is the transmission destination of the combined signal, the updater calculates an FIR filter tap coefficient wₙ in a block LMS (Least Mean Square) algorithm by using the following expression:
wₙ(k+L)=wₙ(k)+μsₙ(k)

3. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = {\sum }_{l = k}^{k + L - 1} {d}_{{n}^{′}} ( l ) {e}_{n}^{*} ( l )$$

4. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = {\sum }_{l = k}^{k + L - 1} c sgn ( {d}_{{n}^{′}} ( l ) ) {e}_{n}^{*} ( l )$$

5. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = {\sum }_{l = k}^{k + L - 1} c sgn ( {d}_{{n}^{′}} ( l ) ) c sgn ( {e}_{n}^{*} ( l ) )$$

6. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = {\sum }_{l = k}^{k + L - 1} {d}_{{n}^{′}} ( l ) c sgn ( {e}_{n}^{*} ( l ) )$$

7. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = c sgn ( {\sum }_{l = k}^{k + L - 1} {d}_{{n}^{′}} ( l ) {e}_{n}^{*} ( l ) ) )$$

8. The communication system according to claim 2, wherein
when L represents the block length, d represents an input signal to the block LMS, e represents the error signal, k and l represent time, n represents the number of the terminal station that is the transmission destination of the combined signal, and n′ represents a number of the other of the terminal stations associated with the interference, the calculator for the correction amount calculates s, which is the correction amount, by using the following expression:
$${s}_{n} ( k ) = c sgn ( {\sum }_{l = k}^{k + L - 1} c sgn ( {d}_{{n}^{′}} ( l ) ) c sgn ( {e}_{n}^{*} ( l ) ) ) )$$

9. The communication system according to claim 2, wherein
the input signal to the block LMS is composed of only the known signal to be included in the signal to be transmitted to the other of the terminal stations associated with the interference signal.

10. A communication method for a hub station and multiple terminal stations to communicate at the same time using the same channel, wherein the communication method comprising:
one of the terminal stations
receiving a signal from the hub station and calculating an error signal between a prescribed known signal and a known signal included in the received signal,
generating the prescribed known signal for another of the terminal stations associated with an interference signal due to a signal to be transmitted from the hub station to the other of the terminal stations, the prescribed known signal being included in the interference signal,
calculating a correction amount of a filter coefficient in an adaptive filter based on the calculated error signal and the generated known signal included in the interference signal, and
transmitting the correction amount to the hub station; and
the hub station
calculating the filter coefficient such that a power of the error signal is minimized based on the correction amount,
generating a transmission signal including the prescribed known signal,
generating a cancellation signal for cancelling the interference signal by performing a filtering process using the filter coefficient on the signal to be transmitted to the other of the terminal stations,
generating a combined signal by combining the transmission signal and the cancellation signal, and
transmitting the combined signal to the one of the terminal stations.
